(19) United States
(12) Patent Application Publication
(10) Pub. No.: US 2020/0280178 A1
(43) Pub. Date: Sep. 3, 2020

(54) ARRANGEMENT HAVING A GAS-INSULATED SWITCHGEAR

(71) Applicant: SIEMENS AKTIENGESELLSCHAFT, MUENCHEN (DE)

(72) Inventors: GUNDOLF BARENTHIN, BERLIN (DE); REINHARD GOEHLER, BERLIN (DE); RALF MERTSCHING, SCHULZENDORF (DE)

(21) Appl. No.: 16/647,910

(22) PCT Filed: Sep. 21, 2018
(86) PCT No.: PCT/EP2018/075551

§ 371 Date: Mar. 17, 2020

(30) Foreign Application Priority Data
Sep. 27, 2017 (DE) 10 2017 217 240.1

(51) Int. Cl. H02B 13/055; H02B 13/035; H01C 7/12

(52) U.S. Cl. CPC H02B 13/055; H01C 7/12; H02B 13/0354

(57) ABSTRACT

An arrangement includes a gas-insulated switchgear which is configured for filling with a first electrical insulation fluid. A surge arrester is provided to reduce the protection level of the gas-insulated switchgear such that the switchgear has insulation spacings of at most the same size as those of a switchgear insulated with a second electrical insulation fluid which has a higher dielectric strength than the first electrical insulation fluid.

The invention relates to an arrangement having a gas-insulated switchgear according to the precharacterizing clause of claim 1.

The product brochure “3ES Surge Arrester Metal-enclosed, SF6-insulated for High Voltage Systems up to 800 kV”, Siemens AG 2008, Order No. E50001-U113-A296-V2-7600, discloses, on page 7, a three-phase, metal-enclosed surge arrester of the 3ES4-K type. The surge arrester has three arrester columns, one column for each phase. The three arrester columns come together at ground in this case. Each arrester column has a plurality of disk-shaped metal oxide varistors which are stacked on top of one another and are pressed together between end fittings by means of tension rods. The surge arrester is designed for use in a gas-insulated switchgear (GIS) and, like the switchgear, is designed for use of sulfur hexafluoride (SF6) as the electrically insulating insulation gas.

The publication “Anwendung der Neptun-Schaltung für Ableiter bei metallgekapselten gasisolierten Metalloxid-Varistor-Ableitern [Use of the Neptune circuit for arresters in metal-enclosed gas-insulated metal oxide varistor arresters]”, published on 5 Sep. 2012 in Journal Technik Up2date2012, Volume No. 10, pages 49 and 50, discloses a three-phase surge arrester having a so-called Neptune circuit. In this case, three arrester columns are connected in an electrically conductive manner on the ground potential side and are connected to the ground potential via a fourth arrester column. As a result, there is a visual similarity to the trident spear of the god Neptune (Greek: Poseidon) from Roman mythology, which gave the Neptune circuit its name.

The product brochure “8VN1 blue GIS up to 145 kV Vacuum interrupting technology and clean air insulation for CO2-neutral footprint”, Article No. EMHP-B10014-00-7600, Siemens AG 2016, discloses a gas-insulated switchgear in which so-called “clean air” is used as the insulation gas. The air-based insulation gas has substantially 80% nitrogen and 20% oxygen, as a result of which the use of climate-damaging SF6 is avoided. In order to keep devices and the installation as compact as possible, sulfur hexafluoride (SF6) was previously used as the insulation medium. Sulfur hexafluoride has been known to be damaging to the climate for a long time and is therefore expensive to use on account of safety obligations and obligations to provide proof. The use of an air-based insulation gas therefore has the advantage that the GIS is environmentally friendly and cost-effective in terms of production and maintenance since, on account of their health and climatic harmlessness, no special proof of safety and disposal needs to be provided for air-based insulation gases. Since the electrical insulation capability of air-based insulation gases is lower than the insulation capability of SF6, devices with air-based insulation gases must provide greater internal clearances or protective distances and are therefore considerably larger, in terms of their design, than comparable SF6 devices. Therefore, the GIS described in the brochure is considerably larger than a comparable SF6 model. The described GIS of the 8VN1 type is designed for 145 kV.

The product brochure “3AV1 blue circuit-breakers—Your solution for a CO2-neutral footprint”, Article No. EMHP-B10014-00-7600, Siemens AG 2016, discloses a switchgear with clean air which is designed for 145 kV. The installation is provided for a lightning impulse voltage of up to 650 kV.

On the basis of known gas-insulated switchgear, the invention is based on the object of specifying an arrangement having a gas-insulated switchgear which is comparatively environmentally friendly, can be produced in a cost-effective manner and is space-saving at the same time.

The invention achieves this object by means of an arrangement as claimed in claim 1.

In the high-voltage sector, the dimensions for electrical installations are determined substantially by the withstand voltage strength in connection with lightning overvoltages and switching overvoltages. This is used by the invention since the withstand voltage strength of the electrical installation is increased by using the surge arrester, with the result that the dimensions can be reduced. Surge arresters were previously not used in gas-insulated switchgear because gas-insulated arresters for high-voltage applications—so-called “encapsulated arresters”—were expensive, on the one hand, and had a certain failure probability, on the other hand. However, in the meantime, encapsulated arresters have become more cost-effective and are so reliable that the operational reliability and availability of an arrangement with a GIS and an arrester are no worse than the operational reliability and availability of a GIS per se.

In one preferred embodiment of the arrangement according to the invention, the second electrical insulation fluid at least proportionally has sulfur hexafluoride. This is an advantage because sulfur hexafluoride has been tried and tested for a long time and has a particularly high electrical dielectric strength.

In one preferred embodiment of the arrangement according to the invention, the first electrical insulation fluid is an air-based insulation gas.

Although air-based electrical insulation gases are environmentally friendly, they have the disadvantage that they are less electrically insulating than the environmentally harmful gas sulfur hexafluoride (SF6). As a result, installations having air-based insulation gases previously had to have greater internal protective distances than installations with SF6 as the protective gas. This results in considerably increased installation dimensions, which entails additional costs for material and transport. In addition, the space for an installation is greatly restricted, particularly in existing electrical installations. In particular retrofitting of gas-insulated switchgear having air-based insulation gases, for example, is therefore difficult or even impossible on account of the larger space requirement. Therefore, a great advantage of the arrangement according to the invention is that a larger space requirement is avoided as a result of the surge arrester which is arranged directly on or in the immediate vicinity of the GIS. This is achieved because the surge arrester reduces the protection level required for the GIS to such an extent that only comparatively smaller insulation spacings are required.

An insulation spacing in the sense of the invention is, for example, the spacing between a part of the switching apparatus to be electrically insulated in the GIS and a housing wall.

A GIS with SF6 as the insulation gas was previously designed, for example, in such a manner that a GIS designed for a voltage of 145 kV to be switched has a withstand voltage strength of 650 kV. For example, the GIS is therefore designed for an insulation spacing of 400 mm. In order to guarantee a withstand voltage strength of 650 kV, the surge arrester is designed for a protection level of 1:1.4 or 71% of the withstand voltage strength. Accordingly, a surge arrester for an SF6-insulated GIS would be designed for a protection level of 450 kV.

For example, the product brochure for the “clean-air” switchgear 8VN1 mentioned at the outset states that dimensions of 1000×3200×5500 mm are provided for the operating voltage of 145 kV. The insulation spacing is accordingly somewhat lower than half the smallest dimension direction, that is to say less than 500 mm in the 8VN1. This example shows that, in previous technology, the insulation spacing increases when using air-based insulation gases. The impaired electrical insulation capacity of air-based insulation gases in comparison with SF6 is also reflected in the fact that a GIS with clean air designed for a voltage of 145 kV to be switched has a withstand voltage strength of 450 kV to 500 kV, for example. Accordingly, the protection level of a surge arrester for such a GIS must be particularly low, that is to say 300 kV to 350 kV, for example. According to the invention, the size of this installation can be reduced, for example, to 800 mm in the smallest dimension direction as a result of the use of a surge arrester, even though clean air, rather than SF6, is used as the insulation gas.

In one preferred embodiment of the arrangement according to the invention, the surge arrester has a pressure equalization device having a gas deflection device, wherein the gas deflection device is designed to deflect emerging gas from the gas-insulated switchgear. In the event of a fault, the pressure equalization device makes it possible for the gas to flow out of the interior of the arrester housing to the outside and is in the form of a membrane, for example, which tears if a pressure threshold value is exceeded. This prevents an explosion of the arrester in the event of a fault. The gas deflection device is arranged on the pressure equalization device and deflects the emerging gas in a predefined direction so that no persons or equipment is/are damaged by the emerging gas. The gas deflection device may be in the form of a so-called “blowout chute”, a component curved like an ear, for example. In this case, the orientation of the gas deflection device or of the blowout chute is selected in such a manner that emerging gas flows away from the GIS. Even if a pressure equalization device having a gas deflection device or a blowout chute is provided in the GIS, this gas deflection device is oriented in such a manner that emerging gas does not strike the surge arrester.

In one preferred embodiment of the arrangement according to the invention, a safety device is provided between the surge arrester and the gas-insulated switchgear. The safety device forms a mechanical barrier which, in the event of a fault, shields both components—the GIS and the arrester—from one another, with the result that damage to the respective other component is prevented. For example, the safety device may be in the form of an electrically non-conductive partition, the material of which at least proportionally has a glass-fiber-reinforced plastic. This is an advantage because glass-fiber-reinforced plastic is non-conductive, is cost-effective and can be processed easily.

In one preferred embodiment of the arrangement according to the invention, the air-based insulation gas for the gas-insulated switchgear has substantially 80% nitrogen and 20% oxygen, and the gas-insulated switchgear is designed for the air-based insulation gas in terms of its insulation spacings. This composition is advantageous because it corresponds substantially to the composition of conventional air. As a result, air which is available everywhere can be used, possibly after drying and purification of particles, pollutants and humidity. Such purified air is known as an air-based insulation gas under the name “Clean-Air” from Siemens AG.

In a further preferred embodiment of the arrangement according to the invention, the switchgear has a vacuum switching device. On account of high insulation resistances of the equipment used with SF6 as the insulation gas and the poor dissemination of the vacuum switching principle, arrester circuits for reducing switching overvoltages were previously required only for transformers in the high-voltage sector. Reducing switching overvoltages directly at the place of origin makes it possible to use alternative insulation gases, such as air, for otherwise identical device dimensions. This embodiment is advantageous because current chopping and reignition—and associated high overvoltages—can occur as a result of the switching in a vacuum. Hitherto, the vacuum switching principle has mainly been used at the medium voltage; in this case, it has been found that such problematic overvoltages can arise. According to the invention, this problem is mastered through the use of the arrester in the immediate spatial vicinity of the switchgear.

In a further preferred embodiment of the arrangement according to the invention, the surge arrester is designed for three-phase high voltage, wherein the surge arrester has a fluid-tight housing for accommodating an electrically insulating insulation fluid and three arrester columns having metal oxide resistance elements. This is an advantage because such so-called encapsulated arresters have been known and tried and tested for a long time in the high-voltage sector.

In a further preferred embodiment of the arrangement according to the invention, the insulation gas is air-based. This is an advantage because the surge arrester is therefore also particularly environmentally friendly.

In a further preferred embodiment of the arrangement according to the invention, the air-based insulation gas for the surge arrester has substantially 80% nitrogen and 20% oxygen, and the surge arrester is designed for the air-based insulation gas in terms of its insulation spacings. The same advantages as those described at the outset for the use of this gas mixture for the GIS analogously arise. With a conventional design, the size of the surge arrester is increased on account of the poorer insulation properties of the air-based insulation gas in comparison with SF6 because larger insulation spacings have to be complied with.

In a further preferred embodiment of the arrangement according to the invention, the metal oxide resistance elements have a diameter of at least 90 mm. In previous surge arresters with a three-phase design, the metal oxide resistance elements are generally in the form of disks with a diameter of approximately 60 mm. According to the invention, metal oxide resistance elements in the form of disks having a diameter of at least 90 mm should be used. Diameters of 95 to 120 mm are particularly preferred. This is an advantage because the arrester protection level and therefore the dielectric strength both of the arrester housing and of the connected GIS can be reduced for an otherwise identical input of energy. Resistors having a larger diameter have comparatively lower specific leakage currents and an improved temperature behavior, that is to say a smaller increase in the electrical conductivity upon heating. This variant consequently has the advantage that the size of the arrester need not be increased even when using air-based insulation gases instead of SF6, which saves space and costs. The diameter is determined transverse to a longitudinal axis through an arrester column. In other words, this embodiment allows a particularly low protection level of the arrester to be implemented.

In a further preferred embodiment of the arrangement according to the invention, the arrester columns are connected in a Neptune circuit. Line-to-ground overvoltage protection with surge arresters is known. However, this has the disadvantage of a high protection level for line-to-line insulation (two line-to-ground arresters in series). Reduced line-to-line protection levels have previously been achieved by means of additional line-to-line arresters (so-called conventional six-arrester circuit). In GIS applications, the six-arrester circuit takes up a lot of space as a result of the connection of the arresters to one another and is not used in current SF6 applications, in particular on account of existing high insulation levels.

As a result of a reduction of the lightning impulse withstand voltage and the switching impulse voltage of the devices and installations between the line and ground with the aid of arresters with a particularly low protection level when using air-based insulation media, additional overvoltage protection is required between the lines. This can be effected by means of a so-called Neptune circuit, wherein a partial arrester is arranged between the line and a virtual neutral point (not in the sense of a conventional neutral point arrester) and a partial arrester is arranged between the virtual neutral point and ground. In order to optimize the protection levels, the individual partial arresters can be adapted according to the invention, for example as explained at the outset by means of resistors with a greater energy absorption capacity and/or by means of a plurality of columns.

An advantage of the present invention involves developing the arrester technology in the high-voltage sector for the purpose of reducing the requirements imposed on the withstand voltage strength of GIS installations, converters, circuit breakers and transformers in conjunction with additional overvoltage protection between the lines in the form of a Neptune circuit. A space-optimized and simultaneously cost-optimized structure with a constant field division is achieved with an accordingly designed three-phase arrester.

In other words, the combination of a Neptune circuit in a high-voltage arrester with enlarged resistance elements allows the implementation of a surge arrester, despite the use of an environmentally friendly air-based insulation gas, without considerably increasing the space requirement for the arrester.

In a further preferred embodiment of the arrangement according to the invention, three arrester columns run in a first longitudinal section of the surge arrester, and a fourth arrester column runs in a second longitudinal section of the surge arrester, wherein the three arrester columns are connected to one another and to the fourth arrester column in an electrically conductive manner by means of a contact means. The virtual neutral point is formed, for example, by a plate which is optimum in terms of the field. In this case, the plate is between the partial arresters, which are between the high-voltage connection and the virtual neutral point, on the one hand, and the partial arrester which is between the virtual neutral point and ground, on the other hand.

In a further preferred embodiment of the arrangement according to the invention, the three arrester columns run parallel to one another in the first longitudinal section. In this case, they may be arranged in the form of a triangle in a plan view, for example, that is to say each column is at a corner of the triangle.

In a further preferred embodiment of the arrangement according to the invention, the three arrester columns run in the first longitudinal section in such a manner that the distance between them becomes shorter in the direction of the contact means. That is to say, for example, each column is oriented with respect to an imaginary edge of a truncated pyramid, wherein the pyramid has the base of an isosceles triangle. This is an advantage because the arrester housing can be particularly narrow in a central region, which saves space.

In a further preferred embodiment of the arrangement according to the invention, the three arrester columns run in the first longitudinal section in such a manner that they are arranged at least at a first end of the first longitudinal section with one of their ends on an imaginary line. This is an advantage because such an arrangement in a row beside one another can be equipped with an oval housing, which means a reduced space requirement for the surge arrester in one direction. This simplifies retrofitting in existing electrotechnical installations, in particular.

In a further preferred embodiment of the arrangement according to the invention, the fourth arrester column runs as a continuation of one of the first three arrester columns in the second longitudinal section. This is an advantage because only three arrester columns have to be produced, namely one long arrester column and two comparatively shorter arrester columns.

In a further preferred embodiment of the arrangement according to the invention, the fourth arrester column is arranged in the second longitudinal section in such a manner that it runs centrally and axially parallel to the first three columns on a midpoint axis. This is an advantage because particularly large protective distances from the housing wall can be achieved by means of the symmetrical arrangement of the central axis, which increases safety. Alternatively, the housing can be narrower in the second longitudinal section than in the first longitudinal section.

In a further preferred embodiment of the arrangement according to the invention, the first and second longitudinal sections are substantially the same length.

In a further preferred embodiment of the arrangement according to the invention, the contact means is arranged between the first and second longitudinal sections.

In a further preferred embodiment of the arrangement according to the invention, the contact means is substantially in the form of a metal plate.

In a further preferred embodiment of the arrangement according to the invention, the contact means has webs which run to the outside in the transverse direction, in the form of a star, from a midpoint axis in the longitudinal direction of the surge arrester.

In a further preferred embodiment of the arrangement according to the invention, the gas-insulated switchgear and the surge arrester are arranged in a common fluid-tight housing.

In a further preferred embodiment of the arrangement according to the invention, the gas-insulated switchgear has at least one input field, and the surge arrester is connected upstream of the input field.

In a further preferred embodiment of the arrangement according to the invention, the gas-insulated switchgear has at least one output field, and the surge arrester is connected downstream of the output field.

In a further preferred embodiment of the arrangement according to the invention, the gas-insulated switchgear has a plurality of busbars, and the surge arrester is assigned to a busbar.

In a further preferred embodiment of the arrangement according to the invention, the busbars can be connected via a coupling field, and the surge arrester is arranged spatially in the coupling field. This is an advantage because there is often still sufficient space for a surge arrester in the coupling field in comparison with other fields, with the result that even the space requirement of the GIS is not increased overall in the ideal situation (footprint, width, height remain unchanged).

On the basis of known electrical installations, the invention is also based on the object of specifying an arrangement having an electrical installation, which is comparatively cost-effective and space-saving at the same time.

Following an alternative configuration of the approach of the invention, the withstand voltage strength of other electrical installations can be increased by means of the surge arrester, with the result that said installations can have smaller dimensions.

In this case, this configuration of the invention can be easily combined with the above-described embodiments of the arrangement having a gas-insulated switchgear which is operated with an air-based insulation gas, in order to produce new advantageous embodiments.

Following this inventive concept, an arrangement having an electrical installation and a surge arrester is provided in order to reduce the protection level of the installation in such a manner that the installation has shorter insulation spacings than an installation without the use of a surge arrester.

In one preferred variant of this alternative configuration of the invention, the electrical installation has at least one of the following items of equipment: voltage transformer, circuit breaker, transformer.

Following another alternative configuration of the approach of the invention, the installation size can be reduced by means of the surge arrester if SF6 continues to be used as the insulation gas. Accordingly, an arrangement having a gas-insulated switchgear which is designed to be filled with sulfur hexafluoride and having a surge arrester is provided in order to reduce the protection level of the gas-insulated switchgear in such a manner that the switchgear has shorter insulation spacings than a gas-insulated switchgear without the use of a surge arrester.

In this case, this configuration of the invention can also be easily combined with the above-described embodiments of the arrangement having a gas-insulated switchgear which is operated with an air-based insulation gas, in order to produce new advantageous embodiments.

For better explanation of the invention,

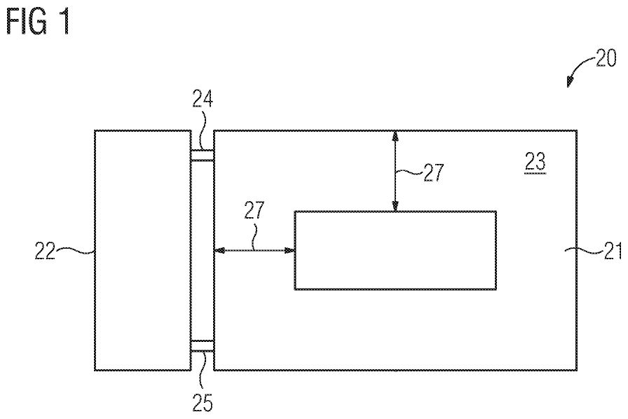

FIG. 1 schematically shows an exemplary embodiment of an arrangement according to the invention, and

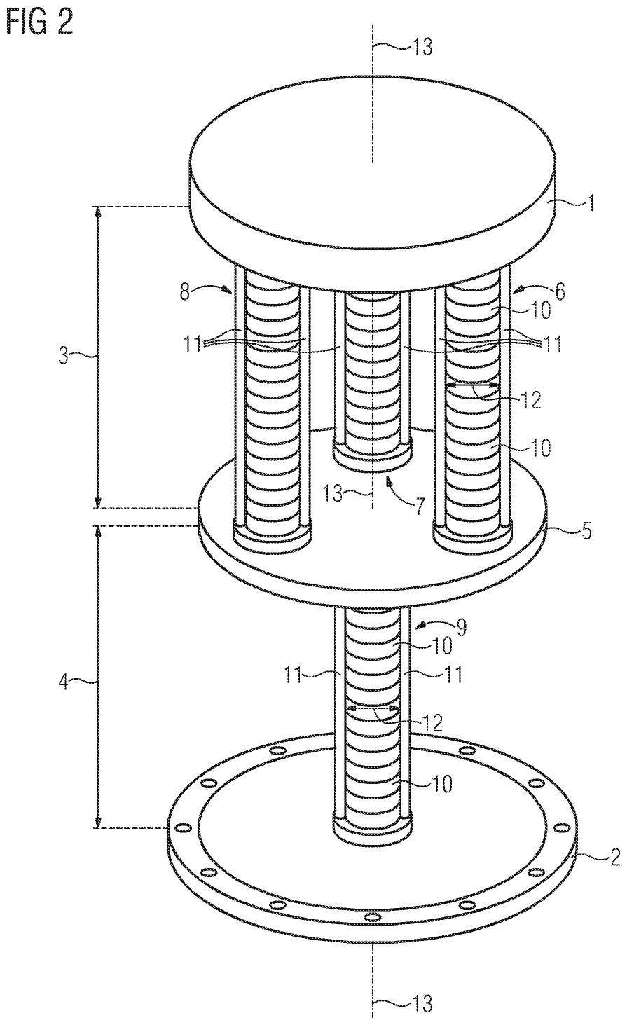

FIG. 2 schematically shows an exemplary embodiment of a surge arrester, and

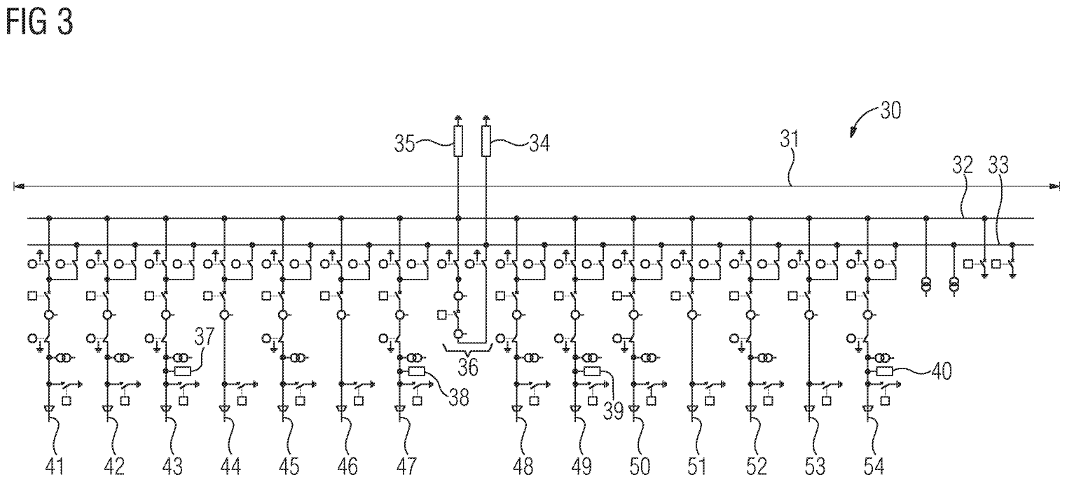

FIG. 3 schematically shows an exemplary embodiment of a circuit diagram of a GIS with surge arresters.

FIG. 1 shows an arrangement 20 having a gas-insulated switchgear 21 which is designed to be filled with an air-based electrical insulation gas 23. A surge arrester 22 is provided in order to reduce the protection level of the gas-insulated switchgear 21 in such a manner that the switchgear 21 has insulation spacings 27 of at most the same size in comparison with a switchgear insulated with sulfur hexafluoride. The surge arrester 22 is arranged in the immediate vicinity of the switchgear 21 and is connected to the latter via electrical connecting pieces 24, 25.

FIG. 2 shows a surge arrester according to the invention for a three-phase high-voltage application, wherein the fluid-tight housing for accommodating an air-based electrical insulation gas is not illustrated. Four arrester columns 6, 7, 8, 9 are connected in a Neptune circuit. The arrester columns 6, 7, 8, 9 have metal oxide resistance elements 10 having a diameter 12 of at least 90 mm. The diameter 12 is determined transverse to a longitudinal axis 13 through the arrester. A first housing cover 1 is provided on the high-voltage side and a second housing cover 2 is provided on the ground-voltage side. Each arrester column is respectively pressed together between two end fittings by means of tension rods 11 (end fittings not illustrated).

Three arrester columns 6, 7, 8 are each arranged at the same distance from one another in a first longitudinal section 3 on the high-voltage side, with the result that a triangular basic shape results in cross section. The first longitudinal section 3 ends with a contact means 5 which connects the three arrester columns 6, 7, 8 to one another and to the fourth arrester column 9 in an electrically conductive manner. A fourth arrester column 9 is arranged in a second longitudinal section 4 in such a manner that it runs centrally and axially parallel to the first three columns 6, 7, 8 on a midpoint axis or longitudinal axis 13. The contact means 5 is substantially in the form of a metal plate and is arranged between the first and second longitudinal sections.

The arrester is designed, in terms of its insulation spacings, for the air-based insulation gas with substantially 80% nitrogen and 20% oxygen.

FIG. 3 shows an exemplary embodiment of a circuit diagram of a GIS with surge arresters. A circuit diagram with a field division of a typical GIS is known from page 16 of the product brochure “Gas-insulated switchgear type series 8DN8 up to 170 kV, 63 kA, 4000 A” from Siemens AG, 2012, Order No. E50001-G620-A122-V1-4A00. In the exemplary embodiment according to the invention, this circuit diagram has been supplemented with surge arresters 34, 35, 37, 38, 39, 40. The gas-insulated switchgear has a length 31 of 15130 mm with a total of 14 input and output fields 41-54. The fields 41-54 are connected to two busbars 32, 33 and can be connected via a coupling field 36.

In this case, provision is made for individual or all input fields of the GIS to be protected with surge arresters so that overvoltages coming from the outside do not damage the GIS. In particular, owing to the risk caused by lightning overvoltages, it is necessary to connect arresters upstream at the input of an overhead line. Depending on the design of the installation, it could be necessary to also use arresters at cable inputs.

It is also useful to use surge arresters in some or all output fields because switching overvoltages, which can occur in vacuum switching technology in particular, are therefore controlled, for example. Damage to equipment connected downstream of the GIS is therefore avoided.

As clear from the above-mentioned brochure, a typical GIS nowadays already has a large space requirement. The installation of surge arresters is therefore particularly readily possible where the corresponding field of the GIS is not completely filled with other assemblies. For example, there is still generally a relatively large amount of space in the coupling field in order to accommodate, for example, the surge arresters 34, 35 and/or the surge arrester 37 without the footprint of the GIS having to be significantly increased.

1-21. (canceled)

22. An arrangement, comprising:
a gas-insulated switchgear (21) configured to be filled with a first electrical insulation fluid (23); and
a surge arrester (22) for reducing a protection level of said gas-insulated switchgear (21) to provide said gas-insulated switchgear (21) with insulation spacings (27) having a size being at most equal to a switchgear insulated with a second electrical insulation fluid having a higher electrical dielectric strength than the first electrical insulation fluid (23).

23. The arrangement according to claim 22, wherein the second electrical insulation fluid has at least a proportion of sulfur hexafluoride.

24. The arrangement according to claim 23, wherein the first electrical insulation fluid (23) is an air-based insulation gas.

25. The arrangement according to claim 24, wherein the air-based insulation gas (23) for said gas-insulated switchgear (21) has substantially 80% nitrogen and 20% oxygen, and said insulation spacings (27) of said gas-insulated switchgear (21) are configured for the air-based insulation gas (23).

26. The arrangement according to claim 22, wherein said gas-insulated switchgear (21) has a vacuum switching device.

27. The arrangement according to claim 22, wherein said surge arrester is configured for three-phase high voltage, and said surge arrester has a fluid-tight housing for accommodating an electrically insulating insulation fluid and three arrester columns (6, 7, 8) having metal oxide resistance elements (10).

28. The arrangement according to claim 27, wherein the insulation fluid for said surge arrester is an air-based insulation gas.

29. The arrangement according to claim 28, wherein the air-based insulation gas for said surge arrester has substantially 80% nitrogen and 20% oxygen, and said insulation spacings of said surge arrester are configured for the air-based insulation gas.

30. The arrangement according to claim 27, wherein said metal oxide resistance elements (10) have a diameter (12) of at least 90 mm.

31. The arrangement according to claim 30, wherein said diameter (12) of said metal oxide resistance elements (10) is measured transverse to a longitudinal axis (13) through one of said arrester columns (6, 7, 8, 9).

32. The arrangement according to claim 27, wherein said arrester columns (6, 7, 8, 9) are connected in a Neptune circuit.

33. The arrangement according to claim 32, wherein:
a first three of said arrester columns (6, 7, 8) run in a first longitudinal section (3) of said surge arrester and a fourth arrester column (9) runs in a second longitudinal section (4) of said surge arrester in said Neptune circuit; and
a contact device (5) electrically conductively connects said three arrester columns (6, 7, 8) to one another and to said fourth arrester column (9).

34. The arrangement according to claim 33, wherein said fourth arrester column (9) runs as a continuation of one of said first three arrester columns (6, 7, 8) in said second longitudinal section.

35. The arrangement according to claim 33, wherein said fourth arrester column (9) disposed in said second longitudinal section (4) runs centrally and axially parallel to said first three arrester columns (6, 7, 8) on a midpoint axis (13).

36. The arrangement according to claim 33, wherein said first and second longitudinal sections (3, 4) have substantially equal lengths.

37. The arrangement according to claim 33, wherein said contact device (5) is disposed between said first and second longitudinal sections (3, 4).

38. The arrangement according to claim 22, which further comprises a fluid-tight housing in which said gas-insulated switchgear (21) and said surge arrester (22) are both disposed.

39. The arrangement according to claim 22, wherein said gas-insulated switchgear has at least one input field (41-54), and said surge arrester is connected upstream of said at least one input field.

40. The arrangement according to claim 39, wherein said gas-insulated switchgear has at least one output field (41-54), and said surge arrester is connected downstream of said at least one output field.

41. The arrangement according to claim 40, wherein said gas-insulated switchgear has a plurality of busbars (21), and said surge arrester is assigned to one of said busbars.

42. The arrangement according to claim 41, which further comprises a coupling field (36) for connecting said busbars (21), said surge arrester being spatially disposed in said coupling field.
